(19) United States
(12) Patent Application Publication
(10) Pub. No.: US 2005/0238922 A1
(43) Pub. Date: Oct. 27, 2005

(54) Substrate with a multilayer reflection film, reflection type mask blank for exposure, reflection type mask for exposure and methods of manufacturing them

(75) Inventors: Takeru Kinoshita, Tokyo (JP); Morio Hosoya, Tokyo (JP); Tsutomu Shoki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: HOYA CORPORATION

(21) Appl. No.: 11/017,873

(22) Filed: Dec. 22, 2004

(30) Foreign Application Priority Data
Dec. 25, 2003 (JP) 429072/2003

(51) Int. Cl. B32B 17/06

(52) U.S. Cl. 428/698; 428/426; 204/192.26; 204/192.27; 204/192.28

(57) ABSTRACT

A multilayer-reflection-film-coated substrate includes a substrate, a multilayer reflection film formed on the substrate and reflecting an exposure light, and a conductive film formed on an opposite side of the substrate from the multilayer reflection film in a region excluding at least a peripheral portion of the substrate. The conductive film is made of a material containing chromium (Cr). The conductive film contains nitrogen (N) on a substrate side and at least one of oxygen (O) and carbon (C) on a surface side. A reflection type mask blank for exposure is obtained by forming an absorber film for absorbing the exposure light on the multilayer reflection film of the multilayer-reflection-film-coated substrate. A reflection type mask is obtained by forming a pattern on the absorber film of the reflection type mask blank for exposure.

This application claims priority to prior Japanese patent application JP2003-429072, the disclosure of which is incorporated herein by reference.

### BACKGROUND OF THE INVENTION

This invention relates to a multilayer-reflection-film-coated substrate having a multilayer reflection film formed on a substrate and reflecting exposure light, a reflection type mask blank for exposure using the above-mentioned substrate, and a reflection type mask for exposure as well as methods of manufacturing them.

Recently, in the semiconductor industry, the EUV lithography (EUVL), which is an exposure technique using extreme ultra violet (Extreme Ultra Violet, EUV) light, is promising following miniaturization of a semiconductor device. It is noted here that the EUV light means light of a wavelength band within a soft X-ray region or a vacuum ultraviolet region, specifically, light having a wavelength of about 0.2-100 nm. As a mask used in the EUV lithography, proposal is made of a reflection type mask for exposure as disclosed in JP-A No. H8-213303.

The reflection type mask mentioned above comprises a multilayer reflection film formed on a substrate for reflecting the EUV light and an absorber film formed as a pattern on the multilayer reflection film for absorbing the EUV light. In an exposure apparatus (pattern transfer apparatus) to which the reflection type mask mentioned above is mounted, exposure light incident to the reflection type mask is absorbed at a part where the absorber film pattern is present and is reflected by the multilayer reflection film at another part where the absorber film pattern is not present to form an optical image which is transferred through a reflection optical system onto a semiconductor substrate (silicon wafer with a resist).

As the multilayer reflection film mentioned above, use is generally made of a multilayer film in which a material having a relatively high refractive index and a material having a relatively low refractive index are alternately laminated by the thickness on the order of several nanometers. For example, a multilayer film obtained by alternately laminating Si films and Mo films is known as a film having high reflectance for the EUV light of 13-14 nm.

The multilayer reflection film may be formed on the substrate, for example, by ion beam sputtering. In case where Mo and Si are contained, ion beam sputtering is carried out by alternately irradiating an ion beam to an Si target and an Mo target so as to form a laminate structure having 30-60 periods, preferably 40 periods. Finally, another Si film is deposited as a protection film. In this event, in order that the multilayer reflection film has a uniform film thickness distribution in a substrate plane, it is preferable to perform deposition by sputtering while the substrate faced to a sputter target surface is rotated around a normal line passing through the center of a principal surface of the substrate as a rotation axis.

For example, the multilayer reflection film may be deposited by the use of an ion beam sputtering apparatus illustrated in FIG. 4. The ion beam sputtering apparatus 40 illustrated in FIG. 4 comprises a sputtering ion source 41, a sputter target supporting member 43, and a substrate supporting member 47 which are disposed within a vacuum chamber 48.

The sputter target supporting member 43 holds sputter targets 44 and 45 for deposition of the multilayer reflection film comprising at least two materials. The sputter target supporting member 43 has a rotation mechanism so that each target is moved to face the sputtering ion source 41.

The substrate supporting member 47 is faced to the sputter target surface and has an angle adjusting member (not shown) which can be arranged at a predetermined angle with respect to the sputter target surface and a rotation mechanism (not shown) for rotating the substrate 1 around the rotation axis which is the normal passing through the center of the principal surface of the substrate.

In order to deposit the multilayer reflection film by sputtering, at first, ions 42 of an inactive gas are extracted from the sputtering ion source 41 and irradiated onto the sputter target 44 (or the sputter target 45). Then, atoms constituting the sputter target 44 (or the sputter target 45) are sputtered and ejected by collision with the ions to generate a target substance 46. At a position faced to the sputter target 44 (or the sputter target 45), the substrate supporting member 47 with the substrate 1 mounted thereto is located. The target substance 46 is deposited to the substrate 1 to form a thin film layer (one of thin film layers forming the alternate multilayer film).

Next, the sputter target supporting member 43 is rotated to face the other sputter target 45 (or the sputter target 44) to the sputtering ion source 41. Then, the other thin film layer forming the alternate multilayer film is deposited. By alternately repeating the above-mentioned operations, the multilayer reflection film comprising several tens to several hundreds of layers is formed on the substrate.

As the above-mentioned substrate supporting member 47, use is made of a mechanical chuck or an electrostatic chuck. Since a load applied to the substrate is low, the electrostatic chuck is preferably used. However, in case of a substrate having low conductivity, such as a glass substrate, a high voltage must be applied in order to obtain a chucking force substantially equivalent to that in case of a silicon wafer. Therefore, dielectric breakdown may be caused to occur.

In order to solve such problems, JP-A No. 2003-501823 (will hereinafter be referred to as a patent document 1) discloses a mask substrate having a back surface coating (conductive film) made of a substance, such as Si, Mo, Cr, chromium oxynitride (CrON), or TaSi, having higher conductivity than that of the glass substrate and serving as a layer promoting electrostatic chucking of the substrate.

However, in the mask substrate disclosed in the patent document 1, as will be understood with reference to FIG. 3A, the above-mentioned conductive film 2 of, for example, CrON is formed throughout an entire area of a back surface of the substrate 1, i.e., not only on one principal surface 11b of the substrate 1 but also on a chamfered surface 12 and a side surface 13 as a peripheral portion thereof. This results in the following problems.

First, adhesion of the CrON film to the glass substrate is weak. Therefore, when the substrate is electrostatically chucked and the multilayer reflection film is formed by ion beam sputtering, film peeling occurs between the glass substrate and the CrON film to produce particles. In particular, in the vicinity of the boundary with the electrostatic chuck 50, film peeling readily occurs because of a force applied to the vicinity of the boundary with the electrostatic chuck 50 due to rotation of the substrate.

Second, the conductive film 2 is formed throughout an entire area of one surface of the substrate 1 including the chamfered surface 12 and the side surface 13. With this structure, film adhesion is particularly weak with respect to the chamfered surface 12 and the side surface 13 of the substrate 1 because the conductive film is obliquely formed on the chamfered surface 12 and the side surface 13. Under this circumstance, warping of the substrate or the like upon electrostatic chucking easily leads to film peeling.

Third, the surface of the conductive film 2 of CrON contains oxygen (O). Therefore, depending upon film deposition conditions, abnormal discharge may occur during deposition of the multilayer reflection film or the absorber film.

Upon occurrence of particles due to the film peeling of the conductive film during the electrostatic chucking (during deposition) or the abnormal discharge during deposition, a product (the multilayer-reflection-film-coated substrate, the reflection type mask blank for exposure, the reflection type mask for exposure) has a large number of defects so that a high-quality product can not be obtained. In case of pattern transfer using a conventional reflection type mask for exposure, exposure light has a wavelength as relatively long as an ultraviolet region (about 150-247 nm). Accordingly, even when a bump and pit defect occurs on the mask surface, the defect hardly becomes a significant defect. Therefore, conventionally, occurrence of the particles upon deposition has not particularly been recognized as a problem to be solved. However, in case where light having a short wavelength, such as the EUV light, is used as the exposure light, even a fine bump and pit defect on the mask surface causes a large influence upon a transferred image. Therefore, the occurrence of the particles can not be ignored. As a result of enthusiastic study, the present inventor has newly found out the problem, i.e., occurrence of particles due to the film peeling of the conductive film upon the electrostatic chucking or the abnormal discharge during deposition.

### SUMMARY OF THE INVENTION

It is therefore a first object of this invention to provide a multilayer-reflection-film-coated substrate which suppresses film peeling of a conductive film upon electrostatic chucking of a substrate provided with the conductive film and occurrence of particles due to abnormal discharge and a method of manufacturing the same.

It is a second object of this invention to provide a high-quality reflection type mask blank for exposure, which is reduced in surface defect caused by particles and a method of manufacturing the same.

It is a third object of this invention to provide a high-quality reflection type mask for exposure, which is free from pattern defects caused by particles and a method of manufacturing the same.

In order to achieve the above-mentioned objects, this invention has the following structures.

(Structure 1)

A multilayer-reflection-film-coated substrate having a multilayer reflection film formed on a substrate for reflecting exposure light, wherein a conductive film is formed on an opposite side of the substrate from the multilayer reflection film in a region excluding at least a peripheral portion of the substrate.

According to the structure 1, the conductive film is formed on the opposite side of the substrate from the multilayer reflection film in the region excluding at least the peripheral portion of the substrate. Thus, the conductive film is not formed on at least a chamfered surface and a side surface of the substrate. Therefore, it is possible to prevent occurrence of particles caused by film peeling at the peripheral portion when the conductive film is formed also on the peripheral portion of the substrate. Accordingly, even when warping of the substrate is caused to occur, for example, upon electrostatic chucking, it is possible to prevent generation of the particles from the peripheral portion of the substrate.

In this invention, the aforementioned peripheral portion of the substrate means the side surface of the substrate perpendicular to a principal surface of the substrate on which the multilayer reflection film is formed and the chamfered surface formed between the principal surface and the side surface.

(Structure 2)

A multilayer-reflection-film-coated substrate having a multilayer reflection film formed on a substrate for reflecting exposure light, wherein a conductive film is formed on an opposite side of the substrate from the multilayer reflection film, the conductive film having a surface comprising a metal nitride film containing substantially no oxygen (O).

According to the structure 2, the surface of the conductive film to be contacted with an electrostatic chuck comprises the metal nitride film containing substantially no hydrogen (O). With this structure, upon depositing the multilayer reflection film or the absorber film, occurrence of abnormal discharge can be avoided. It is therefore possible to prevent generation of particles onto the multilayer reflection film or the absorber film.

(Structure 3)

The multilayer-reflection-film-coated substrate as described in structure 2, wherein the conductive film is a metal nitride film.

According to the structure 3, the conductive film entirely comprises the metal nitride film. Therefore, the adhesion of the conductive film to the substrate is improved and film peeling of the conductive film can be avoided. Consequently, occurrence of particles due to the film peeling can prevented.

(Structure 4)

A multilayer-reflection-film-coated substrate having a multilayer reflection film formed on a substrate for reflecting exposure light, wherein a conductive film made of a material containing metal is formed on an opposite side of the substrate from the multilayer reflection film, the material forming the conductive film having different compositions in a film thickness direction of the conductive film, the conductive film containing nitrogen (N) on a substrate side, and at least one of oxygen (O) and carbon (C) on a surface side.

According to the structure 4, the conductive film made of the material containing metal is formed on the opposite side of the substrate from the multilayer reflection film, and the material forming the conductive film has different compositions in the film thickness direction of the conductive film. The conductive film contains nitrogen (N) on the substrate side and contains at least one of oxygen (O) and carbon (C) on the surface side. With this structure, both the adhesion of the conductive film to the substrate and the adhesion between the electrostatic chuck and the substrate can be improved. Consequently, it is possible to prevent occurrence of the particles caused by film peeling of the conductive film or occurrence of the particles caused by friction between the electrostatic chuck and the substrate resulting from insufficient adhesion between the electrostatic chuck and the substrate. Further, it is possible to avoid film peeling of the conductive film caused by a force applied to the vicinity of the boundary with the electrostatic chuck by rotation of the substrate so as to prevent generation of the particles.

Since the conductive film contains nitrogen (N) on the substrate side, the adhesion of the conductive film to the substrate is improved so as to prevent the film peeling of the conductive film and to reduce the film stress of the conductive film. It is therefore possible to increase the adhesion between the electrostatic chuck and the substrate. In addition, the conductive film contains at least one of oxygen (O) and carbon (C) on the surface side. Therefore, the surface of the conductive film is appropriately roughened and the adhesion between the electrostatic chuck and the substrate upon electrostatic chucking is increased. As a result, it is possible to avoid friction caused between the electrostatic chuck and the substrate. In case where oxygen (O) is contained, the surface roughness of the surface of the conductive film is appropriately roughened (the surface roughness is increased) so that the adhesion between the electrostatic chuck and the substrate is improved. In case where carbon (C) is contained, the resistivity of the conductive film can be reduced so that the adhesion between the electrostatic chuck and the substrate is improved.

Further, the film material of the above-mentioned conductive film has high adhesion to the substrate. Therefore, the film peeling can be suppressed even if the conductive film is formed on the peripheral portion of the substrate, i.e., the chamfered surface or the side surface of the substrate.

(Structure 5)

The multilayer-reflection-film-coated substrate as described in any one of structures 1, 2 and 4, wherein the substrate is a glass substrate and the metal is at least one kind of material selected from a group consisting of chromium (Cr), tantalum (Ta), molybdenum (Mo), and silicon (Si).

According to the structure 5, in case where the substrate material is glass, the metal material constituting the conductive film is at least one kind of material selected from a group consisting of chromium (Cr), tantalum (Ta), molybdenum (Mo), and silicon (Si). With this structure, the adhesion to the substrate is excellent. It is therefore possible to prevent the film peeling and the occurrence of the particles caused by the film peeling.

(Structure 6)

The multilayer-reflection-film-coated substrate as described in any one of structures 1, 2 and 4, wherein the conductive film contains helium (He).

According to the structure 6, the conductive film contains helium (He). It is therefore is possible to further reduce the film stress of the conductive film and to more appropriately roughen the surface of the conductive film. Accordingly, it is possible to further improve the adhesion between the electrostatic chuck and the substrate so that the occurrence of the particles is prevented.

(Structure 7)

A reflection type mask blank for exposure, comprising the multilayer-reflection-film-coated substrate described in any one of structures 1, 2, and 4 and at least an absorber film for absorbing the exposure light and formed on the multilayer reflection film.

According to the structure 7, the reflection type mask blank for exposure is obtained by using the multilayer-reflection-film-coated substrate described in any one of the structures 1, 2 and 4 and forming thereon the absorber film for absorbing the exposure light. Therefore, the reflection type mask blank for exposure is reduced in surface defects caused by the particles.

In addition, between the absorber film and the multilayer reflection film, a buffer film having an etching stopper function for protecting the multilayer reflection film upon forming a pattern onto the absorber film may be provided.

(Structure 8)

A reflection type mask for exposure, comprising the reflection type mask blank described in structure 7 and an absorber film pattern as a transfer pattern formed on the absorber film.

According to the structure 8, the reflection type mask for exposure is obtained by using the reflection type mask blank described in structure 7 and forming the pattern on the absorber film. Therefore, the reflection type mask for exposure is free from pattern defects caused by the particles.

(Structure 9)

A method of manufacturing a multilayer-reflection-film-coated substrate, the method comprising the steps of preparing a conductive-film-coated substrate comprising a substrate and a conductive film formed on the substrate in a region excluding at least a peripheral portion thereof; holding the conductive-film-coated substrate by an electrostatic chuck on the side provided with the conductive film; and forming a multilayer reflection film for reflecting exposure light on an opposite side of the substrate from the conductive film.

According to the structure 9, the conductive-film-coated substrate provided with the conductive film formed in the region excluding at least the peripheral portion of the substrate is used. The conductive-film-coated substrate is held by the electrostatic chuck, and the multilayer reflection film is formed on the opposite side of the substrate from the conductive film. With this structure, it is possible to prevent generation of the particles from the peripheral portion of the substrate upon electrostatic chucking. It is therefore possible to obtain the multilayer-reflection-film-coated substrate free from surface defects caused by the particles.

(Structure 10)

The method of manufacturing a multilayer-reflection-film-coated substrate as described in structure 7, wherein the multilayer reflection film is deposited by sputtering while the conductive-film-coated substrate held by the electrostatic chuck is rotated in the state where the conductive-film-coated substrate is faced to a sputter target surface for depositing the multilayer reflection film.

According to the structure 10, the multilayer reflection film is deposited by sputtering while the conductive-film-coated substrate held by the electrostatic chuck in the structure 9 is rotated in the state where the conductive-film-coated substrate is faced to the sputter target surface for depositing the multilayer reflection film. As a consequence, the multilayer reflection film is formed so as to have a uniform film thickness distribution within the substrate plane. Moreover, since the occurrence of the particles upon the electrostatic chucking can be avoided, it is possible to obtain the multilayer-reflection-film-coated substrate free from surface defects caused by the particles.

(Structure 11)

A method of manufacturing a reflection type mask blank for exposure, the method comprising the step of forming an absorber film for absorbing the exposure light on the multilayer reflection film of the multilayer-reflection-film-coated substrate obtained by the method described in structure 9.

According to the structure 11, the multilayer-reflection-film-coated substrate obtained by the structure 9 is used, and the absorber film for absorbing the exposure light is formed thereon to produce the reflection type mask blank for exposure. In this manner, it is possible to obtain the reflection type mask blank for exposure which is minimized in surface defects caused by the particles.

(Structure 12)

A method of manufacturing a reflection type mask for exposure, the method comprising the step of forming an absorber film pattern as a transfer pattern on the absorber film in the reflection type mask blank obtained by the method described in structure 11.

According to the structure 12, the reflection type mask blank for exposure obtained by the structure 11 is used, and the pattern is formed on the absorber film to produce the reflection type mask for exposure. Thus, it is possible to obtain the reflection type mask for exposure free from pattern defects caused by the particles.

According to this invention, it is possible to prevent occurrence of particles due to the film peeling of the conductive film upon electrostatic chucking of the substrate provided with the conductive film or the abnormal discharge. As a result, by forming the multilayer reflection film for reflecting the exposure light on the substrate held by the electrostatic chuck, it is possible to obtain the multilayer-reflection-film-coated substrate free from surface defects caused by the particles.

Further, according to this invention, by the use of the above-mentioned multilayer-reflection-film-coated substrate and by forming the absorber film for absorbing the exposure light on the multilayer reflection film, it is possible to obtain the high-quality reflection type mask blank for exposure which is minimized in surface defects caused by the particles.

Moreover, according to this invention, by using the aforementioned reflection type mask blank for exposure and by forming the absorber film pattern as the transfer pattern on the absorber film, it is possible to obtain the high-quality reflection type mask for exposure free from pattern defects caused by the particles.

### BRIEF DESCRIPTION OF THE DRAWINGS

FIG. 1A and FIG. 1B are sectional views showing production steps of a multilayer-reflection-film-coated substrate according to this invention;

FIG. 2A through FIG. 2C are sectional views showing production steps of a reflection type mask blank for exposure and a reflection type mask for exposure using the multilayer-reflection-film-coated substrate according to this invention;

FIG. 3A is a sectional view showing a state where a conductive film is formed by the related art;

FIG. 3B is a sectional view showing a state where a conductive film is formed according to an embodiment of this invention;

FIG. 4 is a view showing a general structural of an ion beam sputtering apparatus;

FIG. 5 is a plan view showing a structure of a substrate holder used upon depositing the conductive film;

FIG. 6 is an enlarged perspective view of a portion A in FIG. 5; and

FIG. 7 is a sectional view taken along a line VII-VII line in FIG. 6.

### DESCRIPTION OF THE PREFERRED EMBODIMENTS

Hereinafter, embodiments of this invention will be described in detail.

A multilayer-reflection-film-coated substrate according to a first embodiment of this invention comprises a substrate, a multilayer reflection film formed on the substrate and reflecting exposure light, and a conductive film formed on an opposite side of the substrate from the multilayer reflection film in a region excluding at least a peripheral portion of the substrate.

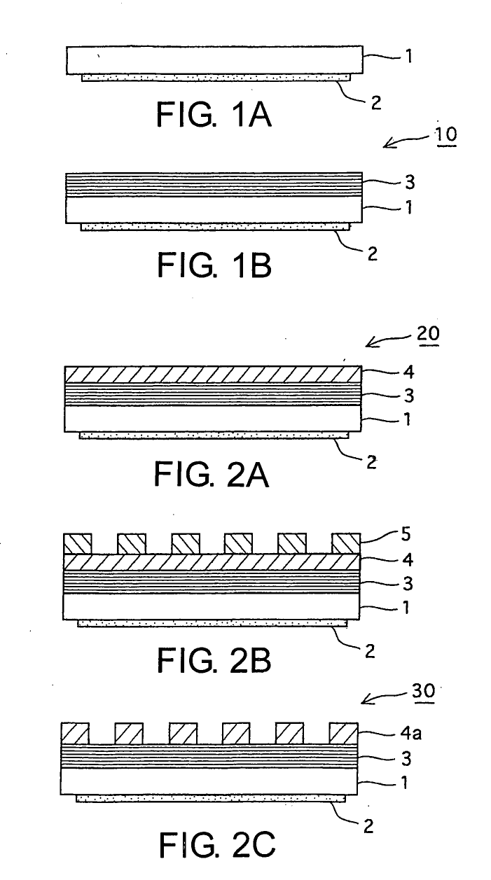

As shown in FIG. 1, the multilayer-reflection-film-coated substrate is obtained by preparing a conductive-film-coated substrate (see FIG. 1A) comprising the substrate 1 and the conductive film 2 formed on the substrate 1 in the region excluding at least the peripheral portion of the substrate 1, and forming the multilayer reflection film 3 on the opposite side of the substrate 1 from the conductive film 2 (see FIG. 1B). The multilayer reflection film 3 may be formed by holding the conductive-film-coated substrate on the side provided with the conductive film 2 by the use of an electrostatic chuck, and performing sputter-deposition while the conductive-film-coated substrate held by the electrostatic chuck is rotated in the state where the conductive-film-coated substrate is faced to a sputter target surface for depositing the multilayer reflection film. As the substrate 1, a glass substrate is preferably used. Therefore, an excellent electrostatic chucking force can be obtained at a low voltage by forming the conductive film 2 on the substrate. In this invention, the conductive film 2 is formed on the substrate 1 in the region excluding at least the peripheral portion thereof. As a consequence, it is possible to prevent generation of particles from the peripheral portion of the substrate upon electrostatic chucking. In this manner, the multilayer-reflection-film-coated substrate 10 free from surface defects caused by the particles can be obtained.

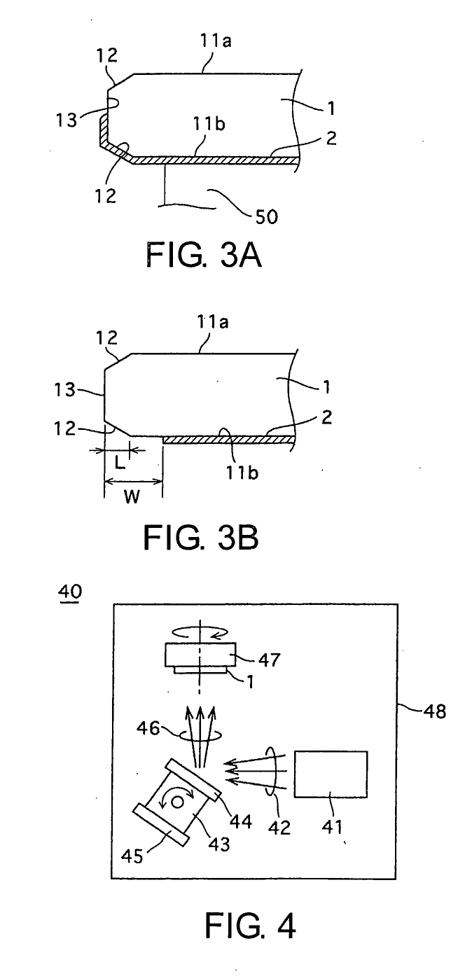

As mentioned above, in this invention, the conductive film 2 is formed on the substrate 1 in the region excluding at least the peripheral portion thereof. Therefore, as will be understood with reference to FIG. 3B, the conductive film 2 may be formed throughout an entire area of one principal surface 11b of the substrate 1 excluding a chamfered surface 12 and a side surface 13 of the substrate 1. Alternatively, the conductive film 2 may be formed on one principal surface 11b of the substrate 1 excluding an inside region extending over a predetermined length W from the side surface 13 of the substrate 1. In this case, the predetermined length W may be appropriately selected by taking the size of the substrate 1, the size (area) of an electrostatic chucking surface, or the like into account and is generally within a range not exceeding 3 cm. It will readily be understood that, since the conductive film 2 is not formed on the chamfered surface 12 of the substrate 1, the lower limit of the predetermined length W is a length L from the side surface 13 of the substrate 1 to the edge of one principal surface 11b.

A multilayer-reflection-film-coated substrate according to a second embodiment of this invention comprises a substrate, a multilayer reflection film formed on the substrate and reflecting exposure light, and a conductive film formed on an opposite side of the substrate from the multilayer reflection film. The conductive film has a surface comprising a metal nitride film containing substantially no oxygen. By forming the conductive film made of such material on the substrate, it is possible to prevent occurrence of abnormal discharge upon depositing the multilayer reflection film or the absorber film. Thus, generation of particles onto the multilayer reflection film or the absorber film can be avoided.

Further, when the conductive film entirely comprises the metal nitride film, adhesion of the conductive film to the substrate is improved. Consequently, film peeling can be prevented upon electrostatic chucking so that generation of particles caused by the film peeling can be avoided.

Since the film material of the conductive film has high adhesion to the substrate, film peeling hardly occurs even if the conductive film is formed at the peripheral portion of the substrate, i.e., the chamfered surface and the side surface of the substrate. However, in order to more reliably prevent generation of particles from the peripheral portion of the substrate, the conductive film made of the aforementioned film material is preferably formed in the region excluding the peripheral portion of the substrate.

A multilayer-reflection-film-coated substrate according to a third embodiment of this invention comprises a substrate, a multilayer reflection film formed on the substrate and reflecting exposure light, and a conductive film made of a material containing metal and formed on an opposite side of the substrate from the multilayer reflection film. The material forming the conductive film has different compositions in a film thickness direction of the conductive film. The conductive film contains nitrogen (N) on a substrate side and contains at least one of oxygen (O) and carbon (C) on a surface side. By forming the conductive film made of such material on the substrate, it is possible to improve both the adhesion of the conductive film to the substrate and the adhesion between the electrostatic chuck and the substrate. As a consequence, it is possible to prevent generation of particles resulting from the film peeling of the conductive film or generation of particles by the friction between the electrostatic chuck and the substrate caused by insufficient adhesion between the electrostatic chuck and the substrate. Since the film material of the conductive film has high adhesion to the substrate, film peeling hardly occurs even if the conductive film is formed at the peripheral portion of the substrate, i.e., the chamfered surface and the side surface of the substrate. However, in order to more reliably prevent generation of particles from the peripheral portion of the substrate, the conductive film made of the aforementioned film material is preferably formed in the region excluding the peripheral portion of the substrate.

In case where the aforementioned substrate material is glass, the metal is preferably at least one kind of material selected from a group consisting of chromium (Cr), tantalum (Ta), molybdenum (Mo), and silicon (Si). Among others, chromium (Cr) is particularly preferable.

In case where the above-mentioned metal is chromium (Cr), a material containing chromium (Cr) and further containing nitrogen (N) may be, for example, CrN or CrCN. In this event, the content of nitrogen (N) preferably falls within a range of 1-60 at %. In particular, in case of CrN, a preferable content of nitrogen (N) falls within a range of 40-60 at %. When the material containing chromium (Cr) contains nitrogen (N) within the above-mentioned range, the adhesion of the conductive film to the substrate is improved and the film stress of the conductive film is reduced. Therefore, the adhesion between the electrostatic chuck and the substrate can be increased. Moreover, in case where the surface of the conductive film is formed of a chromium nitride film (for example, CrN, CrCN) containing substantially no oxygen, it is possible to prevent occurrence of abnormal discharge upon depositing the multilayer reflection film or the absorber film. Further, a material containing chromium (Cr) and at least one of oxygen (O) and carbon (C) may be, for example, CrC or CrON. In this event, the content of oxygen (O) preferably falls within a range of 0.1-50 at % while the content of carbon (C) preferably falls within a range of 0.1-10 at %. When oxygen is contained within the above-mentioned range, the surface roughness of the surface of the conductive film is appropriately increased so that the adhesion between the electrostatic chuck and the substrate can be improved. Further, when carbon (C) is contained within the above-mentioned range, resistivity of the conductive film can be reduced and the adhesion between the electrostatic chuck and the substrate can be improved.

In case where the metal is tantalum (Ta), TaN or TaBN, for example, may be used. Further, in case where the metal is molybdenum (Mo) or silicon (Si), MoN, SiN, or MoSiN, for example, may be used. In this case, the content of nitrogen (N) preferably falls within a range of 10-60 at %. In particular, in case of TaN, a preferable content of nitrogen (N) falls within a range of 5-50 at %. In the manner similar to that mentioned above, when a material containing tantalum (Ta), molybdenum (Mo), and silicon (Si) contains nitrogen (N) within the above-mentioned range, the adhesion of the conductive film to the substrate is improved and the film stress of the conductive film is reduced. As a result, it is possible to increase the adhesion between the electrostatic chuck and the substrate.

Although a deposition method for forming the conductive film on the substrate is not particularly restricted, reactive sputtering, for example, may be preferably used. In case where the material forming the conductive film and containing Cr has different compositions in the film thickness direction of the conductive film and the conductive film contains nitrogen (N) on the substrate side and contains at least one of oxygen (O) and carbon (C) on the surface side, such a conductive film may be formed, for example, by a method of appropriately changing types of additive gas, changing or switching sputter targets, or changing an input voltage (applied voltage) during sputter-deposition of the conductive film. In this case, it is preferable that elements contained in the conductive film are continuously changed from the substrate side towards the surface of the conductive film. Since the elements contained in the conductive film are continuously changed from the substrate side towards the surface of the conductive film, it is possible to improve the adhesion of the conductive film to the substrate and the adhesion between the electrostatic chuck and the substrate by such composition gradient.

As a preferred embodiment, the conductive film may be formed of a lamination film including different materials. As such an embodiment, for example, the conductive film is formed of a lamination film having a three-layer structure of CrN/CrC/CrON or CrN/CrCN/CrON in this order from the substrate side. In this event, the conductive film contains chromium (Cr) and contains nitrogen (N) on the substrate side and oxygen (O) on the surface side. As will readily be understood, the lamination film need not be restricted to the above-mentioned three-layer structure and may comprise two layers such as CrCN/CrON or four or more layers.

In case where the conductive film is formed of the lamination film including different materials, depending upon a combination of the materials, the film stress at the interface between the respective layers constituting the conductive film can be reduced and the adhesion between the electrostatic chuck and the substrate can be increased. Further, the adhesion between the respective layers constituting the conductive film can be increased so as to suppress the film peeling.

Further, as another preferred embodiment, the aforementioned conductive film may contain helium (He). When the conductive film contains helium (He), the film stress of the conductive film can further be reduced and the surface of the conductive film can be more appropriately roughened. As a consequence, it is possible to further increase the adhesion between the electrostatic chuck and the substrate and to advantageously prevent generation of particles. Helium (He) may be contained throughout an entire area of the conductive film, or alternatively, may be contained in a partial layer or region of the conductive film.

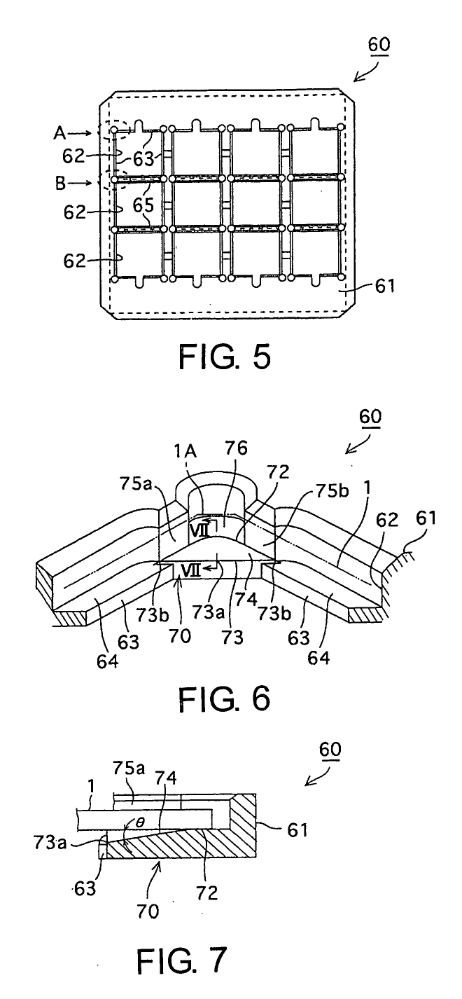

As a method of forming the conductive film on the substrate in the region excluding at least the peripheral portion thereof, use may be made of, for example, a method of sputter-depositing the conductive film on the substrate by the use of a holder for masking (covering) at least the peripheral portion of the substrate so that deposition particles are not deposited at the peripheral portion of the substrate upon depositing the conductive film. Referring to FIG. 5 through FIG. 7, one example of the holder will be explained. FIG. 5 is a plan view showing the holder, FIG. 6 is an enlarged perspective view of a portion A in FIG. 5, and FIG. 7 is a sectional view taken along a line VII-VII in FIG. 6.

The holder 60 includes a rectangular plate 61 chamfered at four corners. For example, the plate 61 has a total of 12 substrate-receiving openings 62 which are formed, for example, in 4×3 matrix arrangement as illustrated in FIG. 5. All of the substrate-receiving openings 62 are equal in size and are formed in a rectangular shape slightly larger than the substrate 1 inserted in the holder 60. Further, on an inside surface of each substrate-receiving opening 62, a protruding portion 63 is integrally formed throughout an entire circumference excluding the four corners and protruding inward so that an upper surface thereof forms a masking surface 64 for masking the peripheral portion of the substrate 1. As shown in FIG. 5, the substrate-receiving openings 62 in the respective rows are separated by ribs 65. Each of the ribs 65 has a width twice as large as that of the protruding portion 63 and an upper surface thereof forms a common masking surface for adjacent ones of the substrates 1 arranged adjacent to each other in a back-and-forth direction. As will readily be understood, the masking surface 64 of the protruding portion 63 and the masking surface of the rib 65 form the same plane.

As illustrated in FIGS. 6 and 7, each of holding portions 70 formed at four corners of the substrate-receiving opening 62 to hold corner portions of the substrate 1 is formed into a plate-like body having a substantially isosceles-triangular shape with an arc-shaped top in plan view and a wedge-like shape in section. The holding portion 70 has an upper surface which constitutes an inclined surface 74 inclined in a funnel-like shape so that the thickness of the holding portion is gradually reduced from an outer edge portion 72 towards a longitudinal center portion 73a of an inner edge portion 73. The inclined surface 74 has an inclination angle θ of 2-3 degrees. The outer edge portion 72 is higher than the masking surface 64 of the protruding portion 63. The center portion 73a as a lowest portion of the inner edge portion 73 has a height higher than or substantially equal to that of the masking surface 64.

Therefore, when each corner portion 1A of the substrate 1 is placed on the holding portion 70, each corner portion 1A is supported in line contact with an upper edge of the outer edge portion 72 as shown in FIG. 7 and is supported in the state where an appropriate space is formed between the masking surface 64 of the protruding portion 63 and the corner portion 1A. Further, at the outside of the holding portion 70, supporting walls 75a, 75b for supporting both side surfaces of the corner portion 1A of the substrate 1 and a working clearance portion 76 are formed. The working clearance portion 76 is formed between the supporting walls 75a, 75b. The inner edge portion 73 of the holding portion 70 has opposite edges 73b each of which is positioned substantially at the widthwise center of a lateral end of the protruding portion 63. As a consequence, the side surfaces of the substrate 1 can be brought into contact with internal wall surfaces of the substrate-receiving opening 62 only at the corner portions 1A supported by the holding portions 70 while the remaining portions of the side surfaces are not brought into contact with the internal wall surfaces.

A portion B of the holder 60 shown in FIG. 5 has a structure substantially similar to that of the portion A and the holding portion 70 except that the substrate-receiving openings 62 are arranged at both sides of the rib 65. Therefore, the description thereof will be omitted.

In the holder 60 having such a structure, if the substrate 1 is inserted into each substrate-receiving opening 62, each corner portion 1A is supported by the outer edge portion 72 of the upper surface of the holding portion 70 in line contact therewith, and the both side surfaces around the corner portion 1A are brought into contact with the supporting wall surfaces 75a, 75b outside the holding portion 70. In this manner, the substrate 1 is positioned. In this state, it is assumed that sputter deposition is performed, for example, from below in FIG. 7. In this event, since at least the peripheral portion of the substrate 1 is covered by the protruding portion 63, the conductive film is formed on the substrate 1 in the region excluding at least the peripheral portion thereof. By selecting the protruding width of the protruding portion 63, it is possible to adjust the region excluding at least the peripheral portion of the substrate 1, where the conductive film is formed.

The above-mentioned holder for masking at least the peripheral portion of the substrate 1 upon deposition is merely one example, and this invention is not restricted to the embodiment in which the conductive film is formed by the use of such a holder.

Moreover, the film thickness of the conductive film formed on the substrate is not particularly restricted but a range on the order of 10-500 nm is typically appropriate.

As a substrate material, a glass substrate may be preferably used. The glass substrate has excellent smoothness and flatness, and is particularly suitable as a substrate for a mask. However, since the conductivity is low, a high voltage is required in order to hold the substrate by the use of the electrostatic chuck. This may cause dielectric breakdown. By contrast, in this invention, the conductive film is formed on the substrate on the side of the electrostatic chuck so that a sufficient chucking force can be obtained even at a low voltage. As the material of the glass substrate, use may be made of amorphous glass (for example, SiO₂—TiO₂ based glass or the like) having a low coefficient of thermal expansion, silica glass, crystallized glass with β-quartz solid solution deposited therein, or the like. The substrate preferably has a smooth surface having a smoothness not greater than 0.2 nm Rms and a flatness not greater than 100 nm in order to obtain high reflectance and high transfer accuracy. In this invention, a unit Rms representative of the smoothness is a root-mean-square roughness and may be measured by the use of an atomic force microscope. The flatness in this invention is a value indicating surface warp (deformation) given by TIR (Total Indicated Reading). This value is an absolute value of a difference in level between a highest position on a substrate surface above a focal plane and a lowest position below the focal plane where the focal plane is a plane determined by the least square method with reference to the substrate surface. The smoothness is given by the smoothness in 10 μm square area while the flatness is given by the flatness in 142 mm square area.

The multilayer reflection film formed on the substrate on the opposite side from the conductive film has a structure in which materials different in refractive index are alternately laminated, and can reflect light having a specific wavelength. For example, use may be made of a Mo/Si multilayer reflection film which has a high reflectance for the EUV light of 13-14 nm and which comprises Mo and Si alternately laminated in about 40 periods. As other examples of the multilayer reflection film used in the region of the EUV light, use may be made of an Ru/Si periodic multilayer reflection film, an Mo/Be periodic multilayer reflection film, an Mo compound/Si compound periodic multilayer reflection film, a Si/Nb periodic multilayer reflection film, an Si/Mo/Ru periodic multilayer reflection film, an Si/Mo/Ru/Mo periodic multilayer reflection film, and an Si/Ru/Mo/Ru periodic multilayer reflection film. A multilayer-reflection-film-coated substrate comprising the above-mentioned multilayer reflection film formed on the substrate may be used, for example, as a multilayer-reflection-film-coated substrate in an EUV reflection type mask blank or an EUV reflection type mask, or a multilayer reflection film mirror in an EUV lithography system.

As mentioned above, the multilayer reflection film may be formed by sputter-depositing while rotating the conductive-film-coated substrate held by the electrostatic chuck in the state where the conductive-film-coated substrate is faced to the sputter target surface for depositing the multilayer reflection film. For example, by using the ion beam sputtering apparatus shown in FIG. 4, the multilayer reflection film may be formed by ion beam sputtering. Since the structure of the apparatus shown in FIG. 4 has been already described, the description thereof will be omitted herein. From the viewpoint of preventing generation of particles caused by target-derived factors upon deposition, the deposition is preferably carried out in the state where the conductive-film-coated substrate is vertically directed. The deposition is carried out while the conductive-film-coated substrate is supported in the above-mentioned state and rotated. Accordingly, if the adhesion of the conductive film to the substrate and the adhesion between the electrostatic chuck and the substrate are weak, particles tend to generate due to film peeling of the conductive film, friction between the electrostatic chuck and the substrate, or the like. In this connection, this invention is particularly preferable.

By forming an absorber film for absorbing exposure light on the multilayer reflection film of the multilayer-reflection-film-coated substrate, a reflection type mask blank for exposure is obtained. If desired, between the multilayer reflection film and the absorber film, a buffer layer may be provided which has resistance against an etching environment upon forming the pattern on the absorber film and serves to protect the multilayer reflection film. According to this invention, the reflection type mask blank is formed by the use of the multilayer-reflection-film-coated substrate mentioned above. Therefore, it is possible to obtain the reflection type mask blank minimized in surface defects caused by the particles.

As a material of the absorber film, selection is made of a material having a high absorptance for the exposure light and a sufficiently high etching selectivity with respect to a film located under the absorber film (typically, the buffer film or the multilayer reflection film). For example, a material containing Ta as a major component is preferable. In this case, if the buffer film is made of a material containing Cr as a major component, a high etching selectivity (10 or higher) can be obtained. The material containing Ta as a major metal element is typically metal or alloy. From the viewpoint of the smoothness and the flatness, a material having an amorphous structure or a microcrystal structure is preferable. As the material containing Ta as a major metal element, use may be made of a material containing Ta and B, a material containing Ta and N, a material containing Ta, B and O, a material containing Ta, B, and N, a material containing Ta and Si, a material containing Ta, Si, and N, a material containing Ta and Ge, a material containing Ta, Ge, and N, or the like. If B, Si, Ge, or the like is added to Ta, an amorphous material can be easily obtained so as to improve the smoothness. If N or O is added to Ta, oxidation resistance is improved so that an effect of improving stability over time can be obtained.

As other materials of the absorber film, use may be made of a material containing Cr as a major component (chromium, chromium nitride, or the like), a material containing tungsten as a major component (tungsten nitride or the like), a material containing titanium as a major component (titanium, titanium nitride), and the like.

These absorber films may be formed by the typical sputtering. Further, the aforementioned buffer film has a function as an etching stopping layer for protecting the multilayer reflection film as an underlayer upon forming the transfer pattern on the absorber film and is generally formed between the multilayer reflection film and the absorber film. The buffer film may be formed if desired.

As a material of the buffer film, a material having a high etching selectivity with respect to the absorber film is selected. The etching selectivity between the buffer film and the absorber film is 5 or higher, preferably 10 or higher, more preferably 20 or higher. Further, a material low in stress and excellent in smoothness is preferable. In particular, a material having smoothness of 0.3 nm Rms or less is desirable. In view of the above, the material forming the buffer film preferably has a microcrystal structure or an amorphous structure.

Generally, as the material of the absorber film, use is often made of Ta, Ta alloy, or the like. If a Ta-based material is used as the material of the absorber film, a material containing Cr is preferably used as the buffer film. For example, use may be made of elemental Cr or a material containing Cr and at least one element selected from the group consisting of nitrogen, oxygen, and carbon added thereto. Specifically, chromium nitride (CrN) or the like may be used.

On the other hand, in case where elemental Cr or a material containing Cr as a major component is used as the absorber film, a material containing Ta as a major component, such as a material containing Ta and B and a material containing Ta, B, and N may be used as the buffer film.

When the reflection type mask is formed, the buffer film may be removed in a patterned shape in conformity with the pattern formed on the absorber film in order to prevent reduction of reflectance of the mask. However, if a material high in transmittance for the exposure light is used as the buffer film so that the film thickness can be sufficiently reduced, the buffer film may not be removed in the patterned shape but may be left so as to cover the multilayer reflection film. The buffer film may be formed by sputtering such as DC sputtering, RF sputtering, and ion beam sputtering.

By forming a predetermined transfer pattern on the absorber film of the reflection type mask blank obtained as mentioned above, the reflection type mask is obtained.

The pattern may be formed on the absorber film by the use of lithography. Referring to FIG. 2A through FIG. 2C, at first, the reflection type mask blank 20 (see FIG. 2A) obtained by forming the absorber film 4 on the multilayer reflection film 3 of the multilayer-reflection-film-coated substrate 10 (see FIG. 1B) according to this invention is prepared. Subsequently, a resist layer is formed on the absorber film 4 of the reflection type mask blank 20, and pattern writing and development are carried out for the resist layer to form a predetermined pattern 5 (see FIG. 2B). The pattern writing may be writing by an electron beam, writing by exposure, or the like. Next, using the resist pattern 5 as a mask, a pattern 4a is formed on the absorber film 4 by etching or the like. For example, in case of the absorber film containing Ta as a major component, dry-etching using a chlorine gas is applicable.

Finally, the remaining resist pattern 5 is removed so that a reflection type mask 30 having the predetermined absorber film pattern 4a is obtained as illustrated in FIG. 2C. In the foregoing description, the aforementioned buffer film is not formed. In case where the buffer film is formed between the absorber film 4 and the multilayer reflection film 3, after forming the pattern 4a on the absorber film 4, the buffer film may be removed in conformity with the absorber film pattern 4a, if desired, so as to expose the multilayer reflection film.

According to this invention, the reflection type mask is formed by the use of the aforementioned reflection type mask blank. Therefore, the reflection type mask without pattern defects caused by the particles can be obtained.

Now, the embodiments of this invention will be explained more in detail in connection with specific examples.

### EXAMPLE 1

As the substrate, an SiO₂—TiO₂ based glass substrate having an outer dimension of 6 inch square and a thickness of 6.3 mm was prepared. The glass substrate had a smooth surface of 0.12 nm Rms and a flatness of 100 nm or less by mechanical polishing.

Then, the glass substrate was placed at a predetermined position of the holder 60 having the structure shown in FIG. 5 through FIG. 7, and sputter deposition of the conductive film was performed by the use of an inline type sputtering apparatus. At first, by using a chromium target, reactive sputtering was carried out in a mixed gas atmosphere of argon (Ar) and nitrogen (N) (Ar: 72 volume %, N₂: 28 volume %, pressure: 0.3 Pa) to form a CrN film having a thickness of 15 nm. Successively, by using a chromium target, reactive sputtering was carried out in a mixed gas atmosphere of argon and methane (Ar: 96.5 volume %, CH₄: 3.5 volume %, pressure: 0.3 Pa) to form a CrC film having a thickness of 25 nm. Finally, by using a chromium target, reactive sputtering was carried out in a mixed gas atmosphere of argon and nitrogen monoxide (Ar: 87.5 volume %, NO: 12.5 volume %, pressure: 0.3 Pa) to form a CrON film having a thickness of 20 nm. The content of nitrogen in the obtained CrN film was 20 at %, the content of carbon in the CrC film was 6 at %, and the contents of oxygen and nitrogen in the CrON film were 45 at % and 25 at %, respectively.

As mentioned above, on the glass substrate, the conductive film comprising a lamination film having a three-layer structure of CrN/CrC/CrON from the substrate side was formed. In this example, by using the aforementioned holder, the conductive film was formed in an area 10 mm inside (i.e., W=10 mm in FIG. 3B) from the side surface of the substrate.

Next, on the substrate with the conductive film formed thereon and on the opposite side from the conductive film, an alternate lamination film made of Mo and Si suitable as a reflection film for an exposure wavelength in the region of 13-14 nm was formed as the multilayer reflection film. The deposition was carried out in the following manner. By the use of the ion beam sputtering apparatus having the structure shown in FIG. 4, the conductive-film-coated substrate was held by the electrostatic chuck on the side where the conductive film was formed. The conductive-film-coated substrate held by the electrostatic chuck was vertically placed and rotated in the state where the substrate was faced to the sputter target surface for depositing the multilayer reflection film. In the above-mentioned state, the sputter deposition was carried out. At first, by using a Si target, an Si film was deposited to 4.2 nm. Thereafter, by using a Mo target, an Mo film was deposited to 2.8 nm. This step was defined as one period. After lamination of 40 periods, another Si film was finally deposited to 4 nm. The total film thickness was equal to 284 nm.

For the multilayer-reflection-film-coated substrate thus obtained in this example, the number of particles on the surface of the multilayer reflection film was measured. As a result, the number was 0.05 defects/cm². Thus, it is understood that generation of particles hardly occurred upon depositing the multilayer reflection film. It is noted here that the particles having a size of 0.15 μm or more were measured by the use of a defect inspection apparatus (MAGICS M-1320 manufactured by Lasertec Corporation).

Then, on the multilayer reflection film of the multilayer-reflection-film-coated substrate obtained as mentioned above, a film containing Ta as a major component, B, and N was deposited as the absorber film for the exposure light having a wavelength of 13-14 nm. The deposition was carried out in the following manner. By using a target containing Ta and B, DC magnetron sputtering was carried out in Ar with 10% nitrogen added thereto. The substrate was held by the electrostatic chuck, and rotated in the state where the substrate was faced to the target surface. In the above-mentioned state, deposition was performed. The thickness thereof was 70 nm as a thickness such that the exposure light is sufficiently absorbed. The deposited TaBN film had a composition of 0.8 Ta, 0.1 B, and 0.1 N.

In the above-mentioned manner, the reflection type mask blank in this example was obtained. The number of the particles on the surface of the absorber film of the reflection type mask blank in this example was measured in the manner similar to that mentioned above. As a result, the number was 0.1 defects/cm². Thus, the mask blank substantially free from surface defects caused by the particles could be obtained.

Next, by using the above-mentioned reflection type mask blank, a pattern was formed on the absorber film. Thus, the reflection type mask having a pattern for 16 Gbit-DRAM with a design rule of 0.07 μm was produced.

At first, the reflection type mask blank was coated with an EB resist, and a resist pattern was formed by EB writing and development. Then, by using the resist pattern as a mask, the TaBN film as the absorber film was dry-etched using chlorine to thereby form an absorber film pattern.

In the above-mentioned manner, the reflection type mask in this example was obtained. By the use of the aforementioned defect inspection apparatus, measurement of pattern defect was performed. As a result, it was found out that the mask had no pattern defect caused by the particles. Further, pattern transfer onto a semiconductor substrate was carried out by the use of the reflection type mask. As a result, an excellent transfer image was obtained.

### EXAMPLE 2

In this example, the multilayer-reflection-film-coated substrate was produced in the manner similar to the example 1 except that the conductive film formed on the substrate had a double-layer structure of CrCN/CrON films. The deposition method of the CrON film was similar to that in the example 1. The deposition of the CrCN film was carried out by the use of the chromium target and by adjusting gas flow rates of methane and nitrogen in a mixed gas atmosphere of argon, methane, and nitrogen. The film thickness was 60 nm. In the obtained CrCN film, the carbon content was 8 at % and the nitrogen content was 12 at %. In the manner similar to the example 1, the conductive film was formed in an area 10 mm inside from the side surface of the substrate.

For the multilayer-reflection-film-coated substrate thus obtained in this example, the number of particles on the surface of the multilayer reflection film was measured. As a result, the number was 1.0 defects/cm². Thus, generation of particles hardly occurred upon depositing the multilayer reflection film.

Then, on the multilayer reflection film of the multilayer-reflection-film-coated substrate obtained as mentioned above, the TaBN film was formed as the absorber film for the exposure light having a wavelength of 13-14 nm in the manner similar to the example 1. Thus, the reflection type mask blank was obtained. The number of particles on the surface of the absorber film of the reflection type mask blank in this example was 1.5 defects/cm². Thus, the reflection type mask blank minimized in surface defects caused by the particles could be obtained.

Next, by using the above-mentioned reflection type mask blank, the pattern was formed on the absorber film in the manner similar to the example 1. Thus, the reflection type mask having a pattern for 16 Gbit-DRAM with a design rule of 0.07 μm was produced. The obtained reflection type mask was subjected to measurement of pattern defects. As a result, it was found out that the pattern defects caused by the particles hardly occurred. Further, pattern transfer onto a semiconductor substrate was carried out by the use of the reflection type mask. As a result, an excellent transfer image was obtained.

### EXAMPLE 3

In this example, the conductive film formed on the substrate was a lamination film having a three-layer structure of CrN/CrC/CrON similar to that of the example 1. The conductive film was formed throughout an entire area of one surface of the substrate, including one principal surface of the substrate as well as the chamfered surface and the side surface of the substrate. In the manner similar to example 1 except the above-mentioned respect, the multilayer-reflection-film-coated substrate was produced. For the multilayer-reflection-film-coated substrate thus obtained in this example, the number of particles on the surface of the multilayer reflection film was measured. As a result, the number was 10 defects/cm². Thus, the number of the particles generated upon depositing the multilayer reflection film was small. In this example, the conductive film was formed also on the chamfered surface and the side surface of the substrate. However, since the conductive film comprising the above-mentioned lamination film had high adhesion to the substrate, generation of particles at the peripheral portion of the substrate could be suppressed.

Then, on the multilayer reflection film of the multilayer-reflection-film-coated substrate obtained as mentioned above, the TaBN film was formed as the absorber film for the exposure light having a wavelength of 13-14 nm in the manner similar to the example 1. Thus, the reflection type mask blank was obtained. The number of particles on the surface of the absorber film of the reflection type mask blank in this example was 13 defects/cm². Thus, the reflection type mask blank reduced in occurrence of surface defects caused by the particles could be obtained.

Next, by using the above-mentioned reflection type mask blank, the pattern was formed on the absorber film in the manner similar to the example 1. Thus, the reflection type mask having a pattern for 16 Gbit-DRAM with a design rule of 0.07 μm was produced. The obtained reflection type mask was subjected to measurement of pattern defects. As a result, it was found out that the pattern defects caused by the particles and resulting in serious problems were minimized. Further, pattern transfer onto a semiconductor substrate was carried out by the use of the reflection type mask. As a result, an excellent transfer image was obtained.

### EXAMPLE 4

In this example, the conductive film formed on the substrate was a lamination film having a three-layer structure of CrN/CrC/CrON similar to that of the example 1. However, the CrC film as the second layer was deposited using a mixed gas of argon and methane with a helium (He) gas further added thereto. The content of the helium gas contained in the mixed gas was 60 volume % while the content of the methane gas was 10 volume %. In the manner similar to the example 3, the conductive film was formed throughout an entire area of one surface of the substrate, including one principal surface of the substrate as well as the chamfered surface and the side surface of the substrate. In the manner similar to example 1 except these respects, the multilayer-reflection-film-coated substrate was produced. By thermal desorption spectroscopy, it was confirmed that helium (He) was contained in the conductive film.

For the multilayer-reflection-film-coated substrate thus obtained in this example, the number of particles on the surface of the multilayer reflection film was measured. As a result, the number was 5 defects/cm². Thus, the number of particles generated upon depositing the multilayer reflection film was very small. In this example, the conductive film was formed also on the chamfered surface and the side surface of the substrate. However, the conductive film comprising the above-mentioned lamination film had high adhesion to the substrate, and helium being contained in the conductive film further increased the adhesion between the electrostatic chuck and substrate. As a consequence, generation of particles at the peripheral portion of the substrate could be suppressed.

Then, on the multilayer reflection film of the multilayer-reflection-film-coated substrate obtained as mentioned above, the TaBN film was formed as the absorber film for the exposure light having a wavelength of 13-14 nm in the manner similar to the example 1. Thus, the reflection type mask blank was obtained. The number of particles on the surface of the absorber film of the reflection type mask blank in this example was 7 defects/cm². Thus, the reflection type mask blank suppressed in occurrence of surface defects caused by the particles could be obtained.

Next, by using the above-mentioned reflection type mask blank, a pattern was formed on the absorber film in the manner similar to the example 1. Thus, the reflection type mask having a pattern for 16 Gbit-DRAM with a design rule of 0.07 μm was produced. The obtained reflection type mask was subjected to measurement of pattern defects. As a result, it was found out that the pattern defects caused by the particles and resulting in serious problems hardly occurred. Further, pattern transfer onto a semiconductor substrate was carried out by the use of the reflection type mask. As a result, an excellent transfer image was obtained.

### EXAMPLE 5

In this example, the multilayer-reflection-film-coated substrate was produced in the manner similar to the example 1 except that the conductive film formed on the substrate was CrN. The deposition of the CrN film was carried out by the use of the chromium target and by adjusting a gas flow rate of nitrogen in a mixed gas atmosphere of argon and nitrogen. The film thickness was 45 nm. In the obtained CrN film, the nitrogen content was 40 at %. In the manner similar to the example 1, the conductive film was formed in an area 10 mm inside from the side surface of the substrate.

For the multilayer-reflection-film-coated substrate thus obtained in this example, the number of particles on the surface of the multilayer reflection film was measured. As a result, the number was 0.03 defects/cm². Thus, generation of particles hardly occurred upon depositing the multilayer reflection film.

Then, on the multilayer reflection film of the multilayer-reflection-film-coated substrate obtained as mentioned above, the TaBN film was formed as the absorber film for the exposure light having a wavelength of 13-14 nm in the manner similar to the example 1. Thus, the reflection type mask blank was obtained. The number of particles on the surface of the absorber film of the reflection type mask blank in this example was 0.07 defects/cm². Thus, the reflection type mask blank minimized in surface defects caused by the particles could be obtained.

Next, by using the above-mentioned reflection type mask blank, the pattern was formed on the absorber film in the manner similar to the example 1. Thus, the reflection type mask having a pattern for 16 Gbit-DRAM with a design rule of 0.07 μm was produced. The obtained reflection type mask was subjected to measurement of pattern defects. As a result, it was found out that the pattern defects caused by the particles hardly occurred. Further, pattern transfer onto a semiconductor substrate was carried out by the use of the reflection type mask. As a result, an excellent transfer image was obtained.

### EXAMPLE 6

In this example, the multilayer-reflection-film-coated substrate was produced in the manner similar to the example 1 except that the conductive film formed on the substrate was TaN. The deposition of the TaN film was carried out by the use of the tantalum target and by adjusting a gas flow rate of nitrogen in a mixed gas atmosphere of argon and nitrogen. The film thickness was 50 nm. In the obtained TaN film, the nitrogen content was 20 at %. In the manner similar to the example 1, the conductive film was formed in an area 10 mm inside from the side surface of the substrate.

For the multilayer-reflection-film-coated substrate thus obtained in this example, the number of particles on the surface of the multilayer reflection film was measured. As a result, the number was 0.03 defects/cm². Thus, generation of particles hardly occurred upon depositing the multilayer reflection film.

Then, on the multilayer reflection film of the multilayer-reflection-film-coated substrate obtained as mentioned above, the TaBN film was formed as the absorber film for the exposure light having a wavelength of 13-14 nm in the manner similar to the example 1. Thus, the reflection type mask blank was obtained. The number of particles on the surface of the absorber film of the reflection type mask blank in this example was 0.1 defects/cm². Thus, the reflection type mask blank minimized in surface defects caused by the particles could be obtained.

Next, by using the above-mentioned reflection type mask blank, the pattern was formed on the absorber film in the manner similar to the example 1. Thus, the reflection type mask having a pattern for 16 Gbit-DRAM with a design rule of 0.07 μm was produced. The obtained reflection type mask was subjected to measurement of pattern defects. As a result, it was found out that the pattern defects caused by the particles hardly occurred. Further, pattern transfer onto a semiconductor substrate was carried out by the use of the reflection type mask. As a result, an excellent transfer image was obtained.

Hereinafter, a comparative example for the above-mentioned examples will be explained.

### COMPARATIVE EXAMPLE

In this comparative example, the conductive film formed on the substrate was a single layer of a CrON film. The deposition method for the CrON film was similar to that of the example 1, and the film thickness was 60 nm. In the manner similar to the example 3, the conductive film was formed throughout an entire area of one surface of the substrate, including one principal surface of the substrate as well as the chamfered surface and the side surface of the substrate. In the manner similar to the example 1 except these respects, the multilayer-reflection-film-coated substrate was produced.

For the multilayer-reflection-film-coated substrate thus obtained in this comparative example, the number of particles on the surface of the multilayer reflection film was measured. As a result, the number was 100 defects/cm². Thus, a very large number of particles were generated upon depositing the multilayer reflection film. This reason is supposed as follows. The CrON film had low adhesion to the glass substrate. In addition, the conductive film was formed also on the chamfered surface and the side surface of the substrate. As a result, a large number of particles were generated by the film peeling of the conductive film, in particular, from the peripheral portion of the substrate.

Then, on the multilayer reflection film of the multilayer-reflection-film-coated substrate obtained as mentioned above, the TaBN film was formed as the absorber film for the exposure light having a wavelength of 13-14 nm in the manner similar to the example 1. Thus, the reflection type mask blank was obtained. The number of particles on the surface of the absorber film of the reflection type mask blank in this comparative example was 113 defects/cm². Thus, a large number of surface defects were caused by the particles.

Next, by using the above-mentioned reflection type mask blank, the pattern was formed on the absorber film in the manner similar to the example 1. Thus, the reflection type mask having a pattern for 16 Gbit-DRAM with a design rule of 0.07 μm was produced. The obtained reflection type mask was subjected to measurement of pattern defects. As a result, a large number of pattern defects caused by the particles were observed.

In the above-mentioned embodiment 1, only the material containing chromium (Cr) is mentioned as a specific example of the material of the conductive film. Besides the above-mentioned material, use may be made of a material containing tantalum (Ta), molybdenum (Mo), silicon (Si), titanium (Ti), tungsten (W), indium (In), or tin (Sn).

While this invention has thus far been described in conjunction with preferred embodiments thereof, it will be readily possible for those skilled in the art to put this invention into practice in various other manners without departing from the scope set forth in the appended claims.

1. A multilayer-reflection-film-coated substrate having a multilayer reflection film formed on a substrate for reflecting exposure light, wherein:
a conductive film is formed on an opposite side of the substrate from the multilayer reflection film in a region excluding at least a peripheral portion of the substrate.

2. A multilayer-reflection-film-coated substrate having a multilayer reflection film formed on a substrate for reflecting exposure light, wherein:
a conductive film is formed on an opposite side of the substrate from the multilayer reflection film;
the conductive film having a surface comprising a metal nitride film containing substantially no oxygen (O).

3. The multilayer-reflection-film-coated substrate as claimed in claim 2, wherein:
the conductive film is a metal nitride film.

4. A multilayer-reflection-film-coated substrate having a multilayer reflection film formed on a substrate for reflecting exposure light, wherein:
a conductive film made of a material containing metal is formed on an opposite side of the substrate from the multilayer reflection film;
the material forming the conductive film having different compositions in a film thickness direction of the conductive film;
the conductive film containing nitrogen (N) on a substrate side and at least one of oxygen (O) and carbon (C) on a surface side.

5. The multilayer-reflection-film-coated substrate as claimed in any one of claims 1, 2 and 4, wherein the substrate is a glass substrate, and the metal is at least one kind of material selected from a group consisting of chromium (Cr), tantalum (Ta), molybdenum (Mo), and silicon (Si).

6. The multilayer-reflection-film-coated substrate as claimed in any one of claims 1, 2 and 4, wherein the conductive film contains helium (He).

7. A reflection type mask blank for exposure, comprising the multilayer-reflection-film-coated substrate claimed in any one of claims 1, 2, and 4 and at least an absorber film for absorbing the exposure light and formed on the multilayer reflection film.

8. A reflection type mask for exposure, comprising the reflection type mask blank claimed in claim 7 and an absorber film pattern as a transfer pattern formed on the absorber film.

9. A method of manufacturing a multilayer-reflection-film-coated substrate, the method comprising the steps of preparing a conductive-film-coated substrate comprising a substrate and a conductive film formed on the substrate in a region excluding at least a peripheral portion thereof; holding the conductive-film-coated substrate by an electrostatic chuck on the side provided with the conductive film; and forming a multilayer reflection film for reflecting exposure light on an opposite side of the substrate from the conductive film.

10. The method of manufacturing a multilayer-reflection-film-coated substrate as claimed in claim 9, wherein the multilayer reflection film is deposited by sputtering while the conductive-film-coated substrate held by the electrostatic chuck is rotated in the state where the conductive-film-coated substrate is faced to a sputter target surface for depositing the multilayer reflection film.

11. A method of manufacturing a reflection type mask blank for exposure, the method comprising the step of forming an absorber film for absorbing the exposure light on the multilayer reflection film of the multilayer-reflection-film-coated substrate obtained by the method claimed in claim 9.

12. A method of manufacturing a reflection type mask for exposure, the method comprising the step of forming an absorber film pattern as a transfer pattern on the absorber film in the reflection type mask blank obtained by the method claimed in claim 11.
